(19) United States
(12) Patent Application Publication
(10) Pub. No.: US 2019/0005159 A1
(43) Pub. Date: Jan. 3, 2019

(54) CONGRUENT ITEM REPLACEMENTS FOR DESIGN MOTIFS

(71) Applicant: Houzz, Inc., Palo Alto, CA (US)

(72) Inventors: Sanjay Raman, San Francisco, CA (US); Richard Chen, Palo Alto, CA (US)

(21) Appl. No.: 15/638,426

(22) Filed: Jun. 30, 2017

(51) Int. Cl. G06F 17/50; G06F 17/30

(52) U.S. Cl. CPC G06F 17/5004; G06F 17/30398; G06F 17/30522

(57) ABSTRACT

A design can be composed of multiple physical items, such as a chair, table, vase, and lamps arranged in a certain configuration. Non-expert users can submit a style criteria that specifies a desired style. Expert design users can select items using the style criteria and place the items in a mock-up or simulation of an environment. The non-expert users can request different items based on specified attributes, such as price. Different items that match the specified attributes, e.g., price, and match the style criteria can automatically be identified and displayed in the simulation.

### TECHNICAL FIELD

Embodiments of the present disclosure relate generally to search engines and, more particularly, but not by way of limitation, to using a specially configured search engine to generate congruent item replacements for design motifs.

### BACKGROUND

In recent years, users have increasingly used image-based search sites to find items (e.g., couches, pillows, sinks, tables, clothes) to decorate their homes, offices, etc. However, images of the items are a poor substitute for the items themselves, since the users cannot inspect the items in real life, e.g., in a showroom. Thus, the users are forced to make decisions based only on the provided images and description data. Further, some users, such as clothing designers or interior designers, seek to create arrangements of items that aesthetically function together in a design or style motif. For example, a clothing designer may select shoes, pants, a shirt, a watch, and a hat to create a stylish outfit, or an interior designer may select a couch, chair, table, vase, and floor lamp to create a living room style motif. While it is difficult to judge individual items using only images, it is far more complex if not impossible for an average user to create an aesthetically pleasing arrangement of items using online images because the user cannot examine how the items look next to one another. Additionally because the user may not have the requisite design experience to create stylish arrangements of items.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a design replacement system operating as part of a networked system, according to some example embodiments.

FIG. 2 shows various internal functional components of a design replacement system, according to some example embodiments.

FIG. 3 shows a flow diagram of a method for implementing new replacement items in a design, according to some example embodiments.

FIG. 4 shows a flow diagram of a method for determining matching replacement items for a design, according to some example embodiments.

FIG. 5 shows a flow diagram of a method for selecting highest ranking matching items for a design, according to some example embodiments.

FIG. 6 shows a user interface of a client device for implementing environment selection, according to some example embodiments.

FIG. 7 shows a user interface of a client device for implementing style selection, according to some example embodiments.

FIG. 8 shows a user interface of a client device for implementing style selection, according to some example embodiments.

FIG. 9 shows a user interface of a client device for selecting items using criteria data, according to some example embodiments.

FIG. 10 shows a user interface of a client device for displaying items in a design, according to some example embodiments.

FIG. 11 shows a user interface of a client device for displaying replacement items per the design, according to some example embodiments.

FIG. 12 shows a network graph data structure for determining replacement items per a design, according to some example embodiments.

FIG. 13 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

A non-expert user can submit style criteria specifying a desired style for an environment selected by the non-expert user. A design expert can review the criteria data and select a plurality of items on a website and arrange the items in a visual representation such as a floor plan or image of a room. The non-expert user can create a request to change some or all of the items selected and arranged by the expert user. For example, the non-expert user may opt to view a similar arrangement of items but at a lower cost. The design replacement system can access a data structure, such as a network graph, to find congruent placement items to include in the design. The replacement items can be identified taking into account the class or type of items (e.g., a chair class, lamp class), a constraint value (e.g., lower price, different materials), and user interactions (e.g., saves, likes) with the items on the website. Once the replacement items are identified, the replacement items replace the initial items in the design. In this way, the non-expert user can find replacement items while maintaining the arrangement of items as arranged by the expert, and further maintaining the selection and style of the item classes as selected by the expert user.

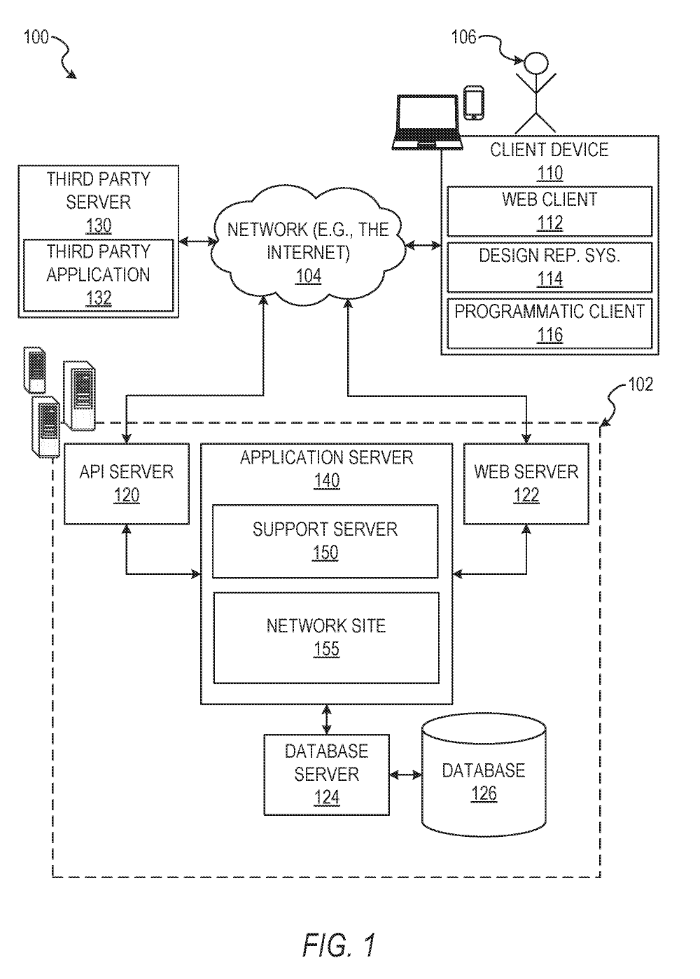

With reference to FIG. 1, an example embodiment of a high-level client-server-based network architecture 100 is shown. A networked system 102 provides server-side functionality via a network 104 (e.g., the Internet or wide area network (WAN)) to one or more client devices 110. In some implementations, a user (e.g., user 106) interacts with the networked system 102 using the client device 110. FIG. 1 illustrates, for example, a web client 112 (e.g., a browser), applications 114 (e.g., a design replacement system, as further discussed below), and a programmatic client 116 executing on the client device 110. The client device 110 includes the web client 112, the client application 114, and the programmatic client 116 alone, together, or in any suitable combination. Although FIG. 1 shows one client device 110, in other implementations, the network architecture 100 comprises multiple client devices 110.

In various implementations, the client device 110 comprises a computing device that includes at least a display and communication capabilities that provide access to the networked system 102 via the network 104. The client device 110 comprises, but is not limited to, a remote device, work station, computer, general purpose computer, Internet appliance, hand-held device, wireless device, portable device, wearable computer, cellular or mobile phone, personal digital assistant (PDA), smart phone, tablet, ultrabook, netbook, laptop, desktop, multi-processor system, microprocessor-based or programmable consumer electronic, game consoles, set-top box, network personal computer (PC), mini-computer, and so forth. In an example embodiment, the client device 110 comprises one or more of a touch screen, accelerometer, gyroscope, biometric sensor, camera, microphone, Global Positioning System (GPS) device, and the like.

The client device 110 communicates with the network 104 via a wired or wireless connection. For example, one or more portions of the network 104 comprises an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a Wireless Fidelity (WI-FI®) network, a Worldwide Interoperability for Microwave Access (WiMax) network, another type of network, or any suitable combination thereof.

In some example embodiments, the client device 110 includes one or more of the applications 114 (also referred to as “apps”) such as, but not limited to, web browsers, book reader apps (operable to read e-books), media apps (operable to present various media forms including audio and video), fitness apps, biometric monitoring apps, messaging apps, electronic mail (email) apps. In some implementations, the client application 114 includes various components operable to present information to the user and communicate with networked system 102.

The web client 112 accesses the various systems of the networked system 102 via the web interface supported by a web server 122. Similarly, the programmatic client 116 and client application 114 accesses the various services and functions provided by the networked system 102 via the programmatic interface provided by an application program interface (API) server 120.

Users (e.g., the user 106) comprise a person, a machine, or other means of interacting with the client device 110. In some example embodiments, the user 106 is not part of the network architecture 100, but interacts with the network architecture 100 via the client device 110 or another means. For instance, the user 106 provides input (e.g., selections of items or other style criteria, or slider generated requests) to the client device 110 and the input is communicated to the networked system 102 via the network 104. In this instance, the networked system 102, in response to receiving the input from the user 106, communicates information to the client device 110 via the network 104 to be presented to the user 106. In this way, the user 106 can interact with the networked system 102 using the client device 110.

The API server 120 and the web server 122 are coupled to, and provide programmatic and web interfaces respectively to, one or more application server 140. The application server 140 can host a support server 150, which can comprise one or more modules or applications 114 and each of which can be embodied as hardware, software, firmware, or any combination thereof. The support server 150 can provide data that is not locally stored on the client device 110. For example, the item catalog, item images, and access to the data structure can be provided to the design replacement system 114 via the support server 150. The application server 140 is, in turn, shown to be coupled to a database server 124 that facilitates access to one or more information storage repositories, such as database 126. In an example embodiment, the database 126 comprises item data, images of items, user profiles, criteria data for styles, saved visual representations displaying arranged items, and the network graph data structure. In some embodiments, some or all of the data stored in database 126 is stored within client device 110 for local access that doesn't require network communications. Additionally, a third party application 132, executing on third party server 130, is shown as having programmatic access to the networked system 102 via the programmatic interface provided by the API server 120. For example, the third party application 132, utilizing information retrieved from the networked system 102, supports one or more features or functions on a website hosted by the third party.

Application server 140 can further host a network site 155, which may be a website that displays webpages for items. The network site 155 has an integrated search engine that allows users 106 to search for items. A webpage for a given item may display one or more images of the item, descriptive data (e.g., title, description of the item, style data), and further be configured to allow a user 106 to purchase the item through the network site 155. Further, users 106 may have user profiles on the network site 155, that the users 106 can access by logging in using respective username and password combinations for the respective users 106. Further, each user profile may have an image gallery, in which users 106 can save items. For example, an image gallery may be an image board and each item webpage may have a “Save to my gallery” button, that saves an item or webpage to the gallery in the user 106's profile on network site 155.

Further, while the client-server-based network architecture 100 shown in FIG. 1 employs a client-server architecture, the present inventive subject matter is, of course, not limited to such an architecture, and can equally well find application in a distributed, or peer-to-peer, architecture system, for example. The various systems of the application server 140 can also be implemented as standalone software programs, which do not necessarily have networking capabilities.

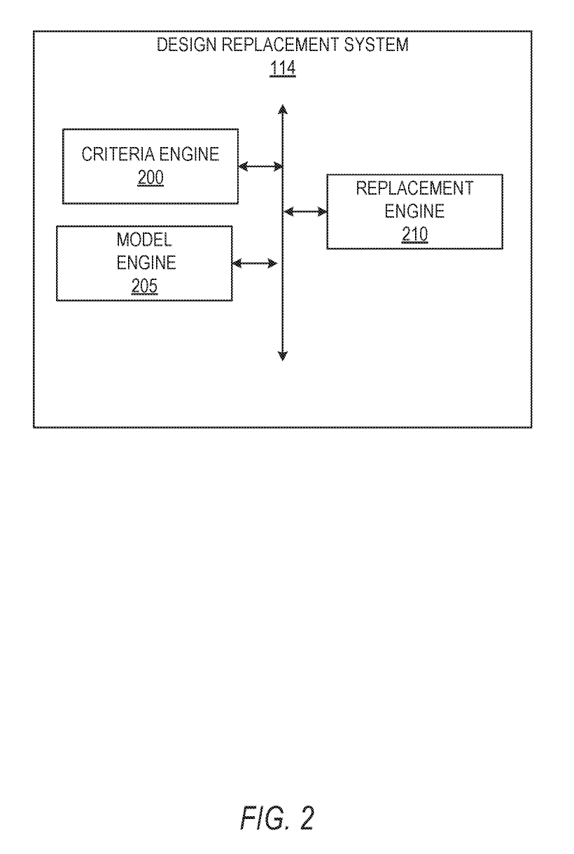

FIG. 2 illustrates a block diagram showing internal functional components provided within the design replacement system 114, according to some embodiments. The components themselves are communicatively coupled (e.g., via appropriate interfaces) to each other and to various data sources, so as to allow information to be passed between the applications 114 or so as to allow the applications 114 to share and access common data. Furthermore, the components access the database 126 via the database server 124. In some example embodiments, the functional components integrated into support server 150 to provide the design replacement approaches discussed herein as a cloud service (e.g., accessible through web client 112.

As illustrated, the design replacement engine 114 comprises a criteria engine 200, a model engine 205, and a replacement engine 210. The criteria engine 200 manages receiving criteria data, e.g., a design motif, from a user 106. The model engine 205 is configured to manage generating representations of the physical items, such as the physical items placed in a two-dimensional representation of a room or the physical items placed in a floor plan showing the respective locations of the physical items in a room. The replacement engine 210 is configured to receive a request for replacement items, and identify items that satisfy criteria data and one or more attributes specified in the request.

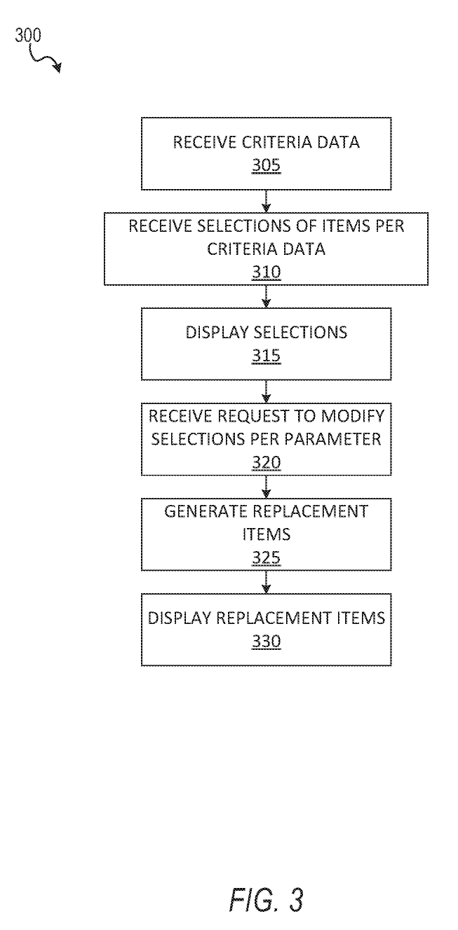

FIG. 3 shows a flow diagram for a method 300 for implementing replacement items in a design, according to some example embodiments. At operation 305, the criteria engine 200 receives criteria data from a first user. The criteria data includes a design motif that is preferred or otherwise selected by the user 106. For example, a given user 106 may prefer minimalist design motifs for home decor. Other examples of design motifs for decor include modern, minimalism, traditional, shabby-chic, eclectic, farmhouse, industrial, midcentury, rustic, Scandinavian, tropical, Victorian. Further, the design motif may correspond to a style of objects not used in home decor. For example, the design motif may specify a style of clothing, e.g., elegant, gothic, bohemian, and other styles of other physical objects.

At operation 310, the criteria engine 200 receives selections of items from a second user, made in accordance with the design motif. For example, after the first user selects his/her criteria data, including a design motif, the criteria data is transmitted to an additional client device of an expert user. The expert user is a user 106 deemed as an design expert, e.g., deemed as a design expert by the first user. In some example embodiments, the first user explicitly chooses a specific design expert as the expert user through a user interface provided by the design replacement system 114. In some example embodiments, once the design motif from the first user is known, the criteria engine 200 accesses a table in database 126 to select designers that specialize in the design motif of the first user. In some example embodiments, per the table in database 126, a plurality of designers are available and the first user can select one of the designers from the plurality as the expert user. Alternatively, the designer having the highest customer reviews is selected as the expert user, according to some example embodiments.

Once the expert user receives the design motif of the first user, the expert user can select items (e.g., couches, chairs, rugs, lamps) that, in the expert user's opinion, satisfy the design motif of the first user. The expert user can further arrange the selected items in a visual representation of an environment. For example, the first user, in the criteria data, may have specified that the design motif is for a given room. The expert user can use a floor plan of the given room to specify locations of the selected items as further discussed below. Further, the expert user can arrange the items in a 3D rendered model or photo of the room, e.g., by overlaying images of the selected items in a mock-up of the given room.

At operation 315, the model engine 205 displays the selected items in a design presentation. For example, the floor plan or image of the room comprising the arranged items is transmitted and displayed on a client device 110 of the first user.

At operation 320, the replacement engine 210 receives a request to modify one or more selected items relative to a specified attribute of the items. For example, the items initially selected and arranged by the expert user may not satisfy the first user. The first user can use a graphical user interface (GUI) element, such as a slider, to request different items that still match the design motif. The GUI element can be configured to select a new value from a range of values for a given attribute. For example, the first set of physical items arranged by the expert user may be too expensive for the first user. The first user, wanting the same design motif for the arranged items but at a lower cost range, can use the GUI element to select a lower value for the price attribute. The request is then received by the replacement engine 210 and processed at operation 325.

At operation 325, the replacement engine 210 generates different items as replacement items to include in the design. Notably, the request for replacement items is not merely a filter that cleaves off more expensive items from items displayed in the arrangement. Instead, the request is for different items that satisfy the new specified price attribute, and additionally satisfy the design motif in the arrangement as configured by the expert user. In this way, the first user can review searchable options of items in a way that maintains the design motif or style, and further maintains the expert arrangement of the expert user. At operation 330, the model engine 205 displays the replacement items in the representation of an environment (e.g., photo of a room, 3D rendered model of a room, floor plan of a room).

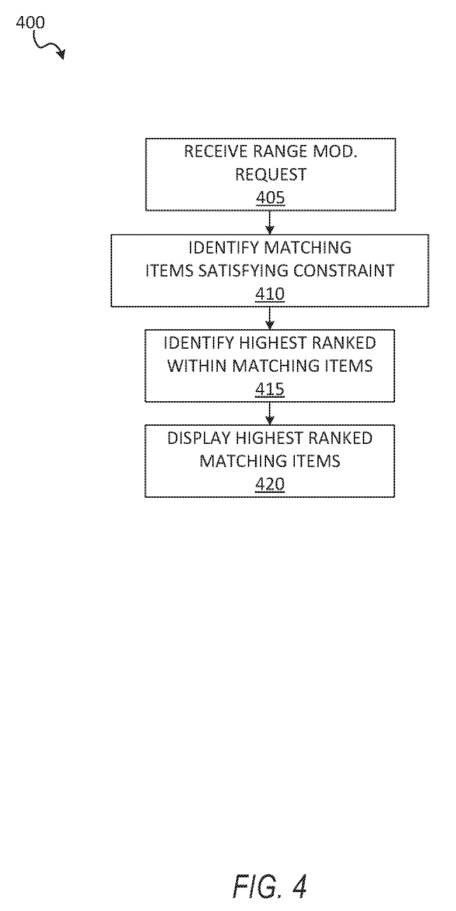

FIG. 4 shows a flow diagram of a method 400 for determining matching replacement items for a design, according to some example embodiments. The operations of method 400 are example operations that can replace operations 320, 325, 330 as a sub-routine, according to some example embodiments. At operation 405, the replacement engine 210 receives a range modification request. The range modification request may specify a new value for an attribute (e.g., lower price of a price attribute) that the replacement items must satisfy. At operation 410, the replacement engine 210 identifies items that satisfy the constraint. For example, at operation 410, the replacement engine 210 accesses a network graph data structure and further identifies item nodes that satisfy the new value. Further, at operation 410, the matching items also satisfy a style attribute to ensure that the replacement items are of the same design motif (e.g., a less expensive art deco lamp should replace a more expensive art deco lamp). However, according to some embodiments, the style attribute is not enforced and the returned matching items may not share the design motif of the originally displayed items. In this way, one item may not match the rest and purposefully stand out as a statement item (e.g., an item that highly contrasts the surrounding items, such as a bright red chair in a beige room). Further, according to some example embodiments, not enforcing the style attribute allows items that were “liked” by an expert user be suggested as replacement items.

At operation 415, the replacement engine 210 determines the highest ranked items within the matching items that satisfy the constraint. For example, from the identified item nodes matching the new value, the highest ranked items nodes, according to user interactions, are selected at operation 415, according to some example embodiments. The user interactions are interactions of users 106 on a network site 155 (e.g., website, mobile device application) in which the items available for arrangement are displayed and searchable online. Examples of user interactions include views of a page (e.g., webpage, app page) that displays a given item, and saves of an item to a user 106's image gallery on the website. Accordingly, the highest ranked item nodes would be webpages of items that have the most page views (e.g., top ten most viewed), or items that have been most saved to a user 106's image gallery on the website to bookmark the respective items. At operation 420, the highest ranked of the matching items are displayed within the arranged design as replacement items. As discussed, a replacement item of a given class or type replaces another item of the same class or type (e.g., a lamp replaces a lamp). In some example embodiments, the highest ranking items are first shown in the arrangement, and the first user 106 can toggle to the other replacement items using toggle GUI controls as discussed below in further detail.

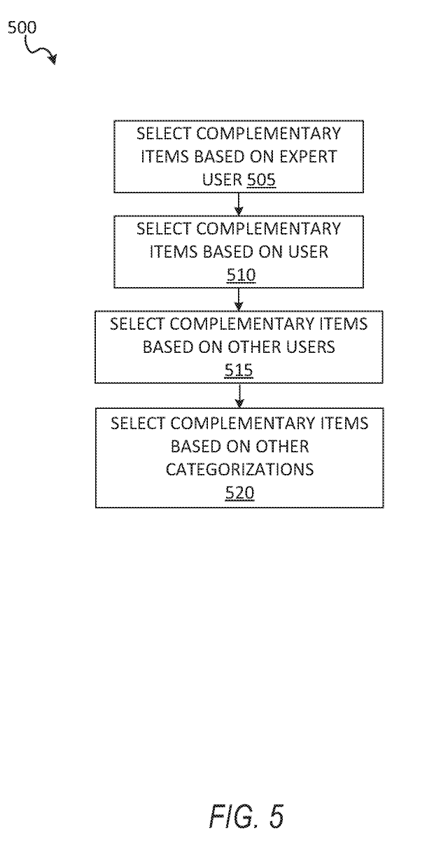

FIG. 5 shows a flow diagram of a method 500 for selecting highest ranking matching items for a design, according to some example embodiments. The operations of method 500 are example operations that can replace operations 325 as a sub-routine, according to some example embodiments. At operation 505, the replacement engine 210 selects items that are complementary, according to an expert user. For example, the expert user may have previously “liked” a first more expensive lamp, and a second less expensive lamp on a network site 155. The second less expensive lamp can then be a congruent complementary item that replaces the more expensive lamp in the arranged items. At operation 510, the replacement engine 210 optionally selects items that are complementary according to the user 106 that submitted the style criteria. For example, the user 106 may have an image gallery in which the user 106 has saved pages of different physical items on the network site 155. In some example embodiments, at operation 510, the replacement engine 210 accesses the image gallery of the user 106 and selects items saved in the gallery as replacement items when the items are of the same class (e.g., a lamp replacing a lamp). At operation 515, the replacement engine 210 optionally selects items that are complementary according to other users 106. For example, the other users 106 may interact with webpages or images on the website (e.g., bookmarking the webpage, purchasing an item of a given page, saving images of an item to a gallery, liking an image). The items having the most user interactions are ranked from greatest to least and the items having the most interactions are included in the arrangement of items. At operation 520, the replacement engine 210 may select complementary items based on other categorizations, such as similarity scores, according to some example embodiments. For example, the replacement engine 210 may use a machine learning scheme (e.g., neural network, support vector machine) to train itself on images of items available on the network site 155. Further, the replacement engine 210 may store each item's similarity to each of the other items in a data structure. Responsive to a request for new items, at operation 520, the replacement engine 210 may select the most visually similar items according to the similarity scores.

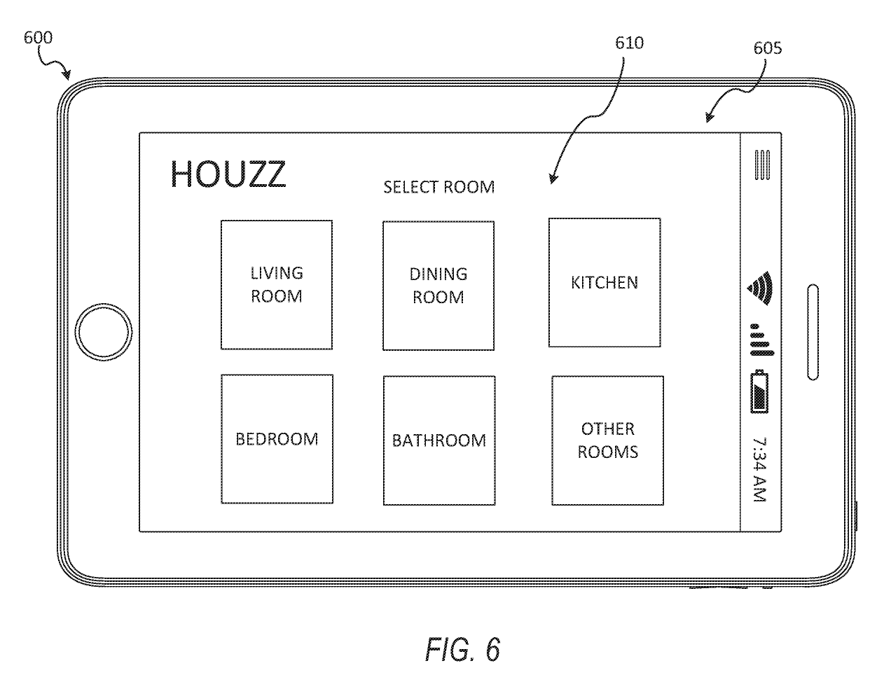

FIG. 6 shows a user interface 605 of a client device 600 for implementing environment selection, according to some example embodiments. The environment is a place in which the items are to be arranged. In the user interface 605, a plurality of GUI elements 610, e.g., buttons, can be used to select an individual environment. For example, the user 106 may select the “bedroom” button. The environment “bedroom” is then included in the criteria data.

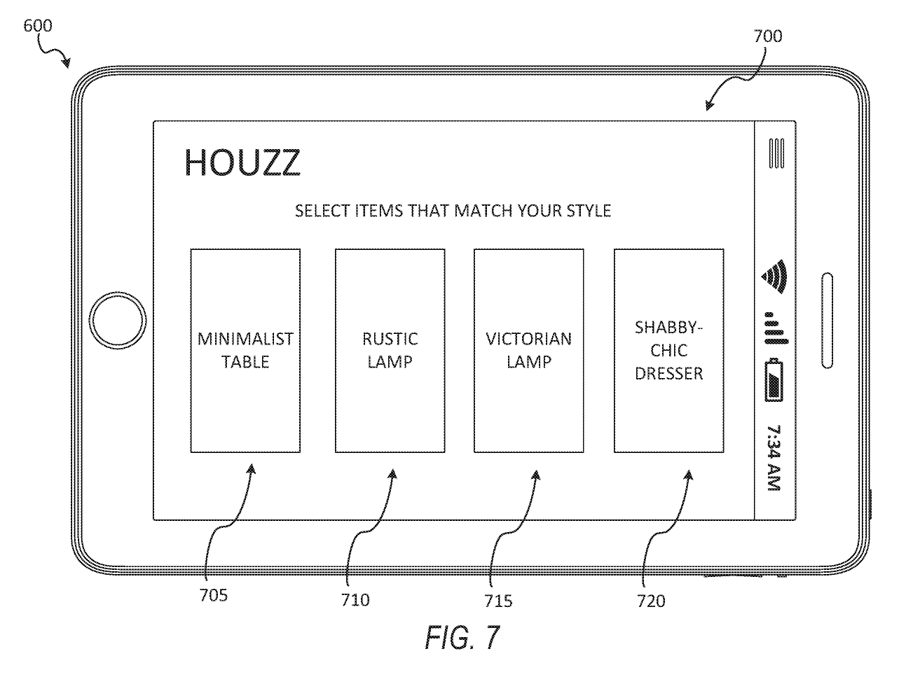

FIG. 7 shows a user interface 700 of a client device 600 for implementing style selection, according to some example embodiments. The user interface 700 is used by the first user to define a design motif for the user 106. In the example illustrated, a plurality of images 705-720 are provided as possible selections for the user 106. Each of the images 705-720 displays an item having a specified style. For example, image 705 displays a table in a style of “minimalist”, image 710 displays a lamp in a “rustic” style, image 715 displays a Victorian lamp, and image 720 displays a shabby-chic dresser. The user 106 can view the plurality of images 705-720 and select those that the user 106 likes most. Additional images on additional user interfaces can show more items to allow the user 106 to choose more preferred items. For example, forty images of items may be displayed on ten screens having user interfaces similar to user interface 700. After the user 106 selects which of the forty images she/he likes, the criteria engine 200 may select the most liked style (as indicated by liking images of that style), and the second most liked style. The first and/or second styles can then be included in the criteria data. For example, if out of forty images, the user 106 likes 23 items of a rustic style, and 14 items of a Victorian style, the rustic style is included as a the most liked style and the Victorian is included as the second most liked style.

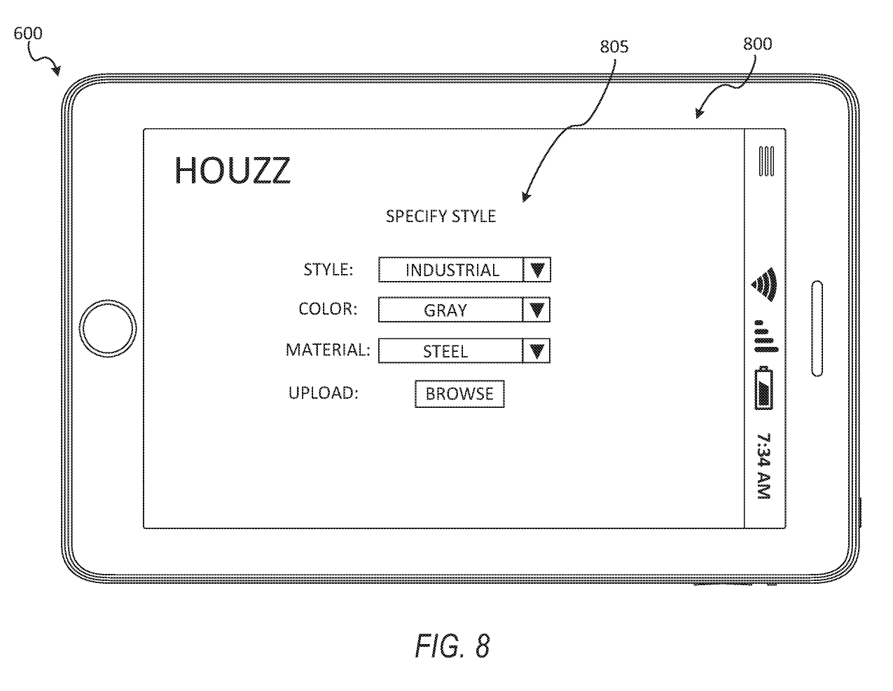

FIG. 8 shows a user interface 800 of a client device 600 for implementing style selection, according to some example embodiments. The user interface 800 comprises style GUI elements 805 that allow the user 106 to explicitly define his/her preferred style. In the example illustrated, the user 106 uses the first drop-down menu to select “industrial” as his/her preferred style from a plurality of styles listed in the menu. The user 106 then uses a color drop-down menu to select “gray” as a preferred color, and likewise uses a material drop-down menu to select “steel” as a preferred material. The selections made using the style GUI elements 805 is then included in the criteria data.

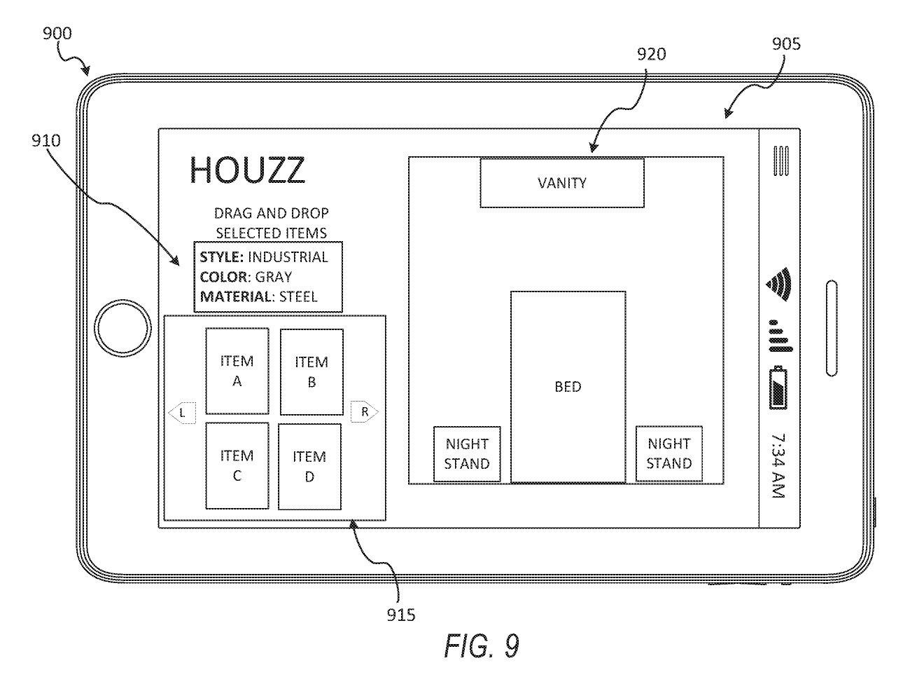

FIG. 9 shows a user interface 905 of a client device 900 for selecting items using criteria data, according to some example embodiments. The client device 900 is a client device of an additional user, e.g., expert user. The expert user receives the criteria data 910, which is displayed within the user interface 905. The expert user can browse an item catalog 915 available on the network site 155 to select items, e.g., items A-B, which the expert user can drag and drop on a visual representation (e.g., floor plan) of an environment (e.g., a bedroom). According to some example embodiments, the item are illustrated as boxes in the floor plan. The arrangement of items includes which items are selected from the item catalog 915 as well as their placement within the environment. The visual representation comprising the arrangement of items is then transmitted to the client device 110 of the user 106 for viewing.

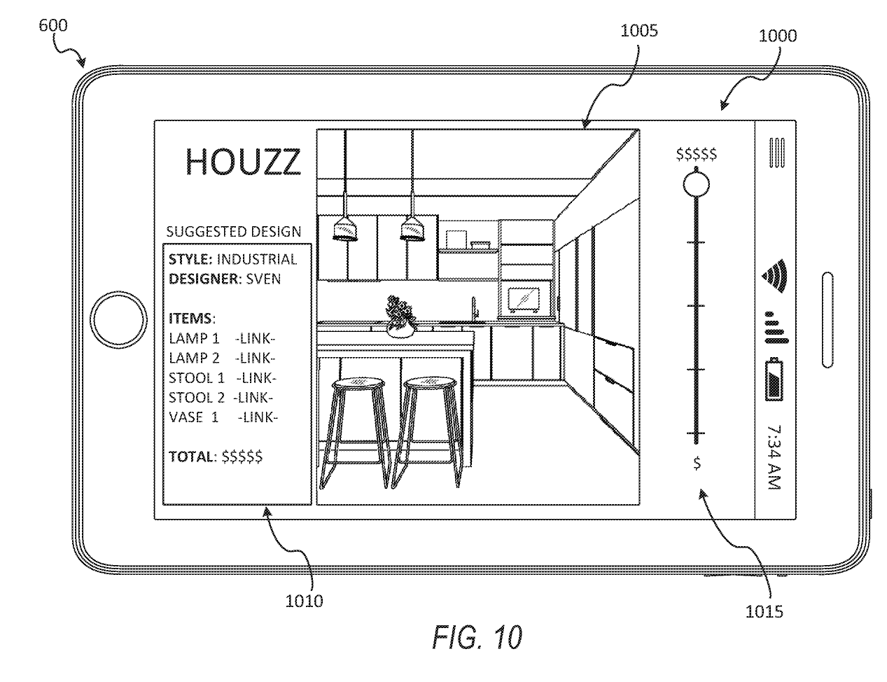

FIG. 10 shows a user interface 1000 of a client device 600 for displaying an arrangement of items in an environment, according to some example embodiments. The user interface 1000 includes a visual representation 1005 of a kitchen that has an arrangement of items including: two stools, a vase, and two hanging lamps. As illustrated, according to some example embodiments, an image or 3D render of a room may be used as the visual representation 1005 of an environment. The user interface 1000 comprises a summary area 1010 listing the selected items, with links to each item (e.g., links to pages on the network site 155 created for each item), and other data, such as the total cost to purchase the items through the network site 155.

In some example embodiments, the model engine 205 displays a 3D model of the room based on a floor plan or measurements received from the user 106 (e.g., the non-expert user that selects the design motif). Further, the expert user selects one or more items, as discussed above, and then places them in the 3D model of the room via the model engine 205. The model engine 205 then outputs a 3D render of the objects in the room for display to the user 106 (e.g., non-expert user).

The user interface 1000 further comprises a GUI element 1015 that the user 106 can use to create a request for different items to replace the items in the design. In particular, the GUI element 1015 is a slider that is movable along a range of values, according to some example embodiments. The top of the range corresponds to the most expensive items and the bottom of the range corresponds to the least expensive items. The example GUI element 1015 has five notches that correspond to levels or thresholds that a user 106 can select to find replacement items for a given selected level. The available items (e.g., items in the catalog) may be pre-categorized in the data structure according to the five levels.

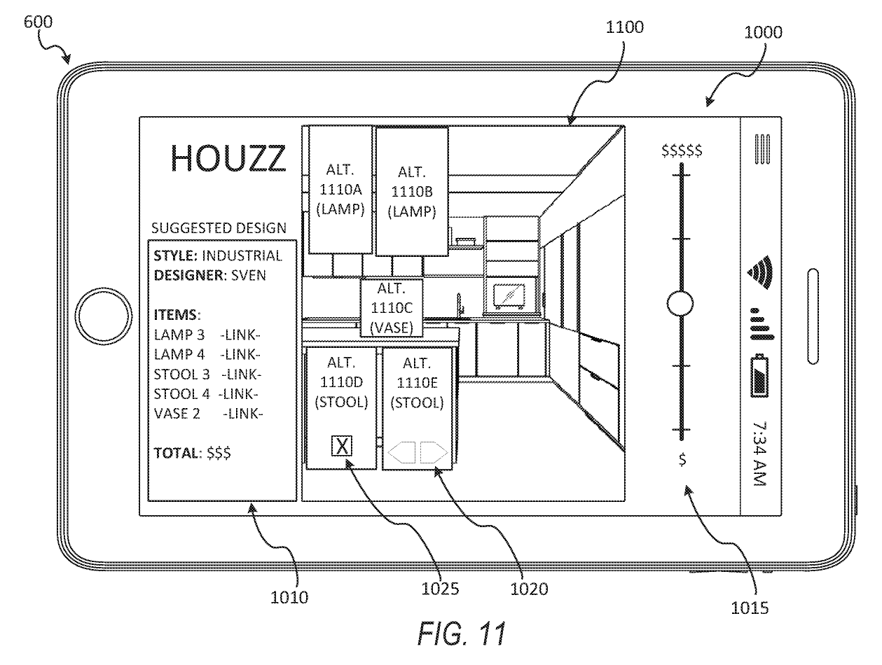

FIG. 11 shows the user interface 1000 of client device 600 with replacement items according to some example embodiments. In response to the user 106 moving the selector of GUI element 1015 to the middle level, new different items that satisfy the new value (e.g., middle price level), as well as satisfy the design motif, are displayed in an updated visual representation 1005. In particular, alternative items 1110A-E replace the items previously shown in FIG. 10. Similarly, the summary area 1010 has been updated to list the new different items with respective links, as well as updated total cost data. Further, according to some example embodiments, GUI elements 1020 (e.g., arrows) can be used to individually replace items in a design. As discussed, multiple items may be replacement items for a particular design, and the first selected item may be the item with the most user interactions. However, the user 106 may not like the item that receives the most user interactions. As such, the user 106 can use GUI elements 1020 to toggle to the item with the second most user actions.

Further, a user 106 may use the GUI element 1015 to find a replacement item for an individual item, instead of finding a full set of replacement items. For example, assume the user 106 is satisfied with the look and cost of the vase 1110C and lamps 1110A and 1110B, however the user 106 thinks stool 1110D costs to much or otherwise does not like the way it looks. The user 106 may select GUI element 1025 to individually select 1110D for replacement. In particular, the user 106 may select GUI element 1025, and move the GUI element 1015 to a new level by sliding it down the range of values. As a result, new replacement items are found just for the stool 1110D. Other items may have similar toggle elements (e.g., GUI elements 1020) and individual selector elements (e.g., GUI element 1025) to more finely tune a design.

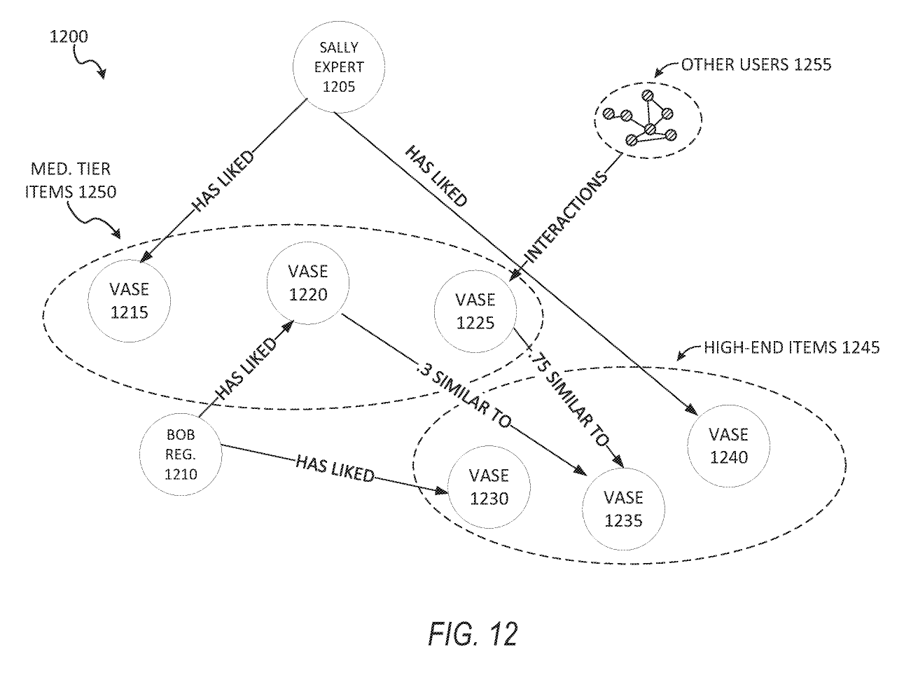

FIG. 12 shows a network graph data structure 1200 for determining replacement items per a design, according to some example embodiments. The network graph data structure 1200 comprises data objects as item nodes, such as vase item nodes 1215-1240, and user nodes, such as expert user node 1205 of “Sally” and regular user node 1210 of “Bob”. The user nodes are designated as a given type, e.g., the expert user node 1205 is associated with a user profile having a designation of expert. Each item node corresponds to a item page on a network site 155, according to some example embodiments.

Interactions between users 106 and items are represented by edges, lines, or arrows connecting the nodes. As discussed above, the interactions may be user interactions between a user 106 of a network site 155 and items displayed on the network site 155. For example, the expert node 1205 has “liked” vase 1215 and vase 1240 on a network site 155, and the interactions are displayed as relationship arrows from expert node 1205 to vase 1215 and vase 1240. Similarly, the non-expert user 1210 has “liked” vase 1220 and 1230. Further, other users 1255 may likewise interact with nodes, as illustrated by the interactions arrow from other users 1255 to vase 1225.

Although only vase nodes are displayed for clarify, it is appreciated that network graph data structure 1200 may comprise nodes for every item available or viewable on the network site 155. Assuming, as an example, the user 106 is submitting a request to find different items for the vase in a given design (e.g., FIGS. 10 and 11), the user 106 may select the vase using a checkbox and move the slider to middle tier, which causes the replacement engine 210 to generate a request. Responsive to the request, first nodes being of the item class are identified. For example, vase nodes are identified. According to some example embodiments, item nodes not being of the style specified by the user 106 in the design criteria are also excluded.

Further responsive to the request, item nodes having the specified attribute are identified. Thus, in the example illustrated, medium tier items 1250 which have medium cost are identified, and high end items 1245 are excluded. Further, responsive to the request, user interactions are used to identify specific replacement items, as discussed with reference to FIG. 5 above. In some example embodiments, items associated by the expert user are returned as replacement items. For example, as illustrated, the expert user has liked vase 1215 and vase 1240. Assume, vase 1240 was initially included in the arrangement of items, then responsive to the request, the other “liked” vase 1215, which is less expensive, is displayed in the design as a replacement item. Further, assume the user 106 that submitted the design criteria is the user 106 of non-expert node 1210, “Bob”. Bob has previously liked vase 1220 and vase 1230, the former being less expensive than the latter. Responsive to the request, the replacement engine 210 may access Bob's user data to find replacements. In particular, for example, the replacement engine 210 determines that Bob liked vase 1220, thus vase 1220 can be used as replacement item for vase 1230.

Further, as discussed above, other attributes of nodes can be used to find replacement items. For example, assume other users 1255 of the network site 155 most like, save, highly review, or purchase vase 1225. Further assume vase 1235 was included in the first arrangement of items and the user 106 submitted a request for replacement items. Responsive to the request, the replacement engine 210 may select the most interacted with item as the replacement item. Thus, the item node for vase 1225 is identified and used to replace vase 1235. The user 106 may then toggle to the second most interacted with item using toggle controls as discussed above.

In some example embodiments, replacement items are the items that are most visually similar to the initial items. Visual similarity can be learned through machine learning images (e.g., neural networks, support vector machines) of the item nodes and assigning similarity scores for each of the items that have similar shape or form with respect to one another. For example, assume vase 1235 is initially included in a design by the expert user. Further assume that the replacement engine 210 has used a machine learning module to create visual similarity scores for each of the item nodes 1215, 1220, 1225, which are from the medium tier items 1250. The similarity score may be stored in a relationship (e.g., edge or arrow) between nodes. Responsive to the request for new different items at a new value (e.g., medium price value), the replacement engine 210 may select, as a replacement item, the item node which has the most visually similar score to vase 1235. In the example of FIG. 12, vase 1225 may be most similar to vase 1235 according to the score data in the relationship. Accordingly, vase 1225 is selected as a replacement item for vase 1235 in the design.

Further, in some example embodiments, edges may connect item nodes that correspond to items depicted in the same image. For example, an image of a living room may items such as lamp_1, chair_1, and footstool_1. The nodes that correspond to the lamp_1, chair_1, and footstool_1 then have edges connected to each other denoting the relationship of appearing the same image together.

The edge relationship of appearing in the same image together can be used to find replacement items per a design motif according to some example embodiments. Continuing the example, further assume that different image of a different living room depicts lamp_2, chair_1, and footstool_2 (where the chair_1 is the chair that appears in both images of the different living rooms). The item node corresponding to chair_1 then may have edges that connect it to lamp_1, lamp_2, footstool_1, and footstool_2. If a user seeks to replace lamp_1, lamp_2 may be recommended because chair_1 has been depicted with both lamp_1 and lamp_2, albeit in different images. That is, in other words, a query is generated to request any lamps that appear in other items that appear with depict lamp_1. As a result, because chair_1 is depicted with lamp_2 in the different image of the different living room, lamp_2 is recommended as a replacement item. This approach can capture relationships between items that do not necessarily share the same attributes. For example, lamp_1, chair_1, and footstool_1 may all be of different design styles, but still be selected by an expert designer as being stylish together. Likewise for lamp_2, chair_2, and footstool_2; that is, lamp_2, chair_2, and footstool_2 may share attributes or may have entirely different attributes but nonetheless assumed to be related to each because a design has arranged them together. More complex queries are also available in the appeared-together approach (e.g., requesting a replacement item using a appeared together in the same image relationship and further requesting that the replacement item be less than a certain dollar amount).

Further, in some example embodiments, the item(s) suggested need not necessarily replace a previously suggested item. In particular, for example, the edge relationships may use the edge relationships of the design graph to suggest a new item of a different type from those suggested. Using the example above, an expert has selected chair_1, and footstool_1. The user may request a lamp that matches chair_1 and footstool_1. In response to the user's request, the design graph is utilized to recommend lamp_1 based lamp_1 appearing in images with chair_1 and footstool_1 (e.g., thereby sharing edges in the design graph).

Certain embodiments are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some embodiments, a hardware module can be implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an application specific integrated circuit (ASIC). A hardware module may also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network 104 (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules can be located in a single geographic location (e.g., within a home environment, an office environment, or a server farm). In other example embodiments, the processors or processor-implemented modules are distributed across a number of geographic locations.

The modules, methods, applications 114 and so forth described in conjunction with FIGS. 1-12 are implemented in some embodiments in the context of a machine and an associated software architecture. The sections below describe representative software architecture and machine (e.g., hardware) architecture that are suitable for use with the disclosed embodiments.

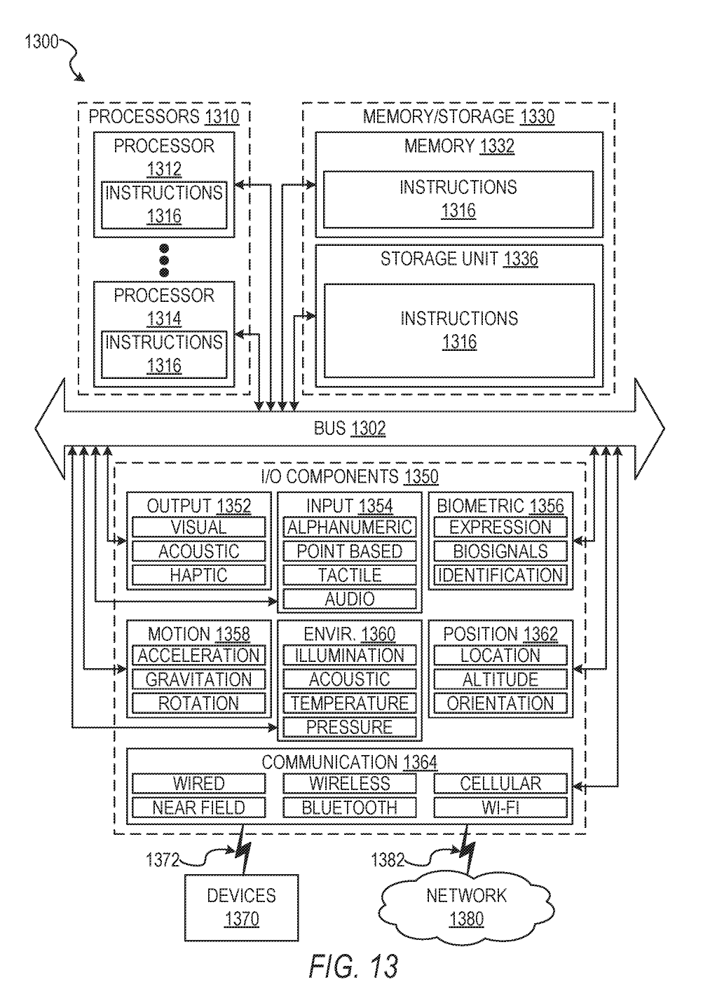

FIG. 13 is a block diagram illustrating components of a machine 1300, according to some example embodiments, able to read instructions from a machine-readable medium (e.g., a machine-readable storage medium) and perform any one or more of the methodologies discussed herein. Specifically, FIG. 13 shows a diagrammatic representation of the machine 1300 in the example form of a computer system, within which instructions 1316 (e.g., software, a program, an application, an applet, an app, or other executable code) for causing the machine 1300 to perform any one or more of the methodologies discussed herein can be executed. For example, the instructions 1316 can cause the machine 1300 to execute the flow diagrams of FIGS. 3-5. Additionally, or alternatively, the instruction 1316 can implement the criteria engine 200, model engine 205, and replacement engine 210 of FIG. 2, and so forth. The instructions 1316 transform the general, non-programmed machine 1300 into a particular machine programmed to carry out the described and illustrated functions in the manner described. In alternative embodiments, the machine 1300 operates as a standalone device or can be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1316, sequentially or otherwise, that specify actions to be taken by the machine 1300. Further, while only a single machine 1300 is illustrated, the term “machine” shall also be taken to include a collection of machines 1300 that individually or jointly execute the instructions 1316 to perform any one or more of the methodologies discussed herein.

The machine 1300 can include processors 1310, memory/storage 1330, and I/O components 1350, which can be configured to communicate with each other such as via a bus 1302. In an example embodiment, the processors 1310 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) can include, for example, processor 1312 and processor 1314 that may execute instructions 1316. The term “processor” is intended to include multi-core processor 1310 that may comprise two or more independent processors 1312, 1314 (sometimes referred to as “cores”) that can execute instructions 1316 contemporaneously. Although FIG. 13 shows multiple processors 1310, the machine 1300 may include a single processor 1310 with a single core, a single processor 1310 with multiple cores (e.g., a multi-core processor), multiple processors 1310 with a single core, multiple processors 1310 with multiples cores, or any combination thereof.

The memory/storage 1330 can include a memory 1332, such as a main memory, or other memory storage, and a storage unit 1336, both accessible to the processors 1310 such as via the bus 1302. The storage unit 1336 and memory 1332 store the instructions 1316, embodying any one or more of the methodologies or functions described herein. The instructions 1316 can also reside, completely or partially, within the memory 1332, within the storage unit 1336, within at least one of the processors 1310 (e.g., within the processor's cache memory), or any suitable combination thereof, during execution thereof by the machine 1300. Accordingly, the memory 1332, the storage unit 1336, and the memory of the processors 1310 are examples of machine-readable media.

As used herein, the term “machine-readable medium” means a device able to store instructions 1316 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)) or any suitable combination thereof. The term “machine-readable medium” should be taken to include a single medium or multiple media (e.g., a centralized or distributed database, or associated caches and servers) able to store instructions 1316. The term “machine-readable medium” shall also be taken to include any medium, or combination of multiple media, that is capable of storing instructions (e.g., instructions 1316) for execution by a machine (e.g., machine 1300), such that the instructions 1316, when executed by one or more processors of the machine 1300 (e.g., processors 1310), cause the machine 1300 to perform any one or more of the methodologies described herein. Accordingly, a “machine-readable medium” refers to a single storage apparatus or device, as well as “cloud-based”storage systems or storage networks that include multiple storage apparatus or devices. The term “machine-readable medium” excludes signals per se.

The I/O components 1350 can include a wide variety of components to receive input, provide output, produce output, transmit information, exchange information, capture measurements, and so on. The specific I/O components 1350 that are included in a particular machine will depend on the type of machine. For example, portable machines such as mobile phones will likely include a touch input device or other such input mechanisms, while a headless server machine will likely not include such a touch input device. It will be appreciated that the I/O components 1350 can include many other components that are not shown in FIG. 13. The I/O components 1350 are grouped according to functionality merely for simplifying the following discussion, and the grouping is in no way limiting. In various example embodiments, the I/O components 1350 can include output components 1352 and input components 1354. The output components 1352 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1354 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In further example embodiments, the I/O components 1350 can include biometric components 1356, motion components 1358, environmental components 1360, or position components 1362 among a wide array of other components. For example, the biometric components 1356 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1358 can include acceleration sensor components (e.g., an accelerometer), gravitation sensor components, rotation sensor components (e.g., a gyroscope), and so forth. The environmental components 1360 can include, for example, illumination sensor components (e.g., a photometer), temperature sensor components (e.g., one or more thermometers that detect ambient temperature), humidity sensor components, pressure sensor components (e.g., a barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 1362 can include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 1350 may include communication components 1364 operable to couple the machine 1300 to a network 1380 or devices 1370 via a coupling 1382 and a coupling 1372, respectively. For example, the communication components 1364 include a network interface component or other suitable device to interface with the network 1380. In further examples, communication components 1364 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 1370 may be another machine or any of a wide variety of peripheral devices (e.g., a peripheral device coupled via a Universal Serial Bus (USB)).

Moreover, the communication components 1364 can detect identifiers or include components operable to detect identifiers. For example, the communication components 1364 can include radio frequency identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 1364, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 1380 can be an ad hoc network, an intranet, an extranet, a virtual private network (VPN), a local area network (LAN), a wireless LAN ((WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a WI-FI® network, another type of network, or a combination of two or more such networks. For example, the network 1380 or a portion of the network 1380 may include a wireless or cellular network, and the coupling 1382 may be a Code Division Multiple Access (CDMA) connection, a Global System for Mobile communications (GSM) connection, or other type of cellular or wireless coupling. In this example, the coupling 1382 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1316 can be transmitted or received over the network 1380 using a transmission medium via a network interface device (e.g., a network interface component included in the communication components 1364) and utilizing any one of a number of well-known transfer protocols (e.g., Hypertext Transfer Protocol (HTTP)). Similarly, the instructions 1316 can be transmitted or received using a transmission medium via the coupling 1372 (e.g., a peer-to-peer coupling) to devices 1370. The term “transmission medium” shall be taken to include any intangible medium that is capable of storing, encoding, or carrying the instructions 1316 for execution by the machine 1300, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, from a client device of a user, criteria data specifying a design motif for physical items;
identifying a set of one or more physical items that correspond to the criteria data;
receiving, from the client device, a request to modify the set of one or more physical items to include one or more different items that satisfy the criteria data and one or more attributes of the different items specified in the request;
responsive to the request, generating the one or more different items by accessing a data structure to identify the one or more different items that satisfy the criteria data and satisfy the one or more specified attributes; and
causing, using at least one processor of a machine, a presentation of the generated different items on a display device.

2. The method of claim 1, wherein the request to modify is generated using a graphical user interface element that selects a new value, from a range of values, using the one or more specified attributes of the different items.

3. The method of claim 1, wherein the set of one or more physical items is identified by operations comprising:
receiving, from an additional client device of an additional user, one or more selections for the set of the one or more physical items, the one or more selections selected by an additional user using the design motif.

4. The method of claim 3, further comprising:
transmitting the criteria data to the additional user;
receiving, from the additional user, placement of the one or more physical items in a visual representation of an environment.

5. The method of claim 4, wherein the design motif includes at least one of: modern, minimalism, traditional, shabby-chic, eclectic, farmhouse, industrial, midcentury, rustic, Scandinavian, tropical, Victorian.

6. The method of claim 4, wherein the visual representation is at least one of: an image of an environment, a floorplan.

7. The method of claim 1, wherein the one or more different items are identified using operations comprising:
identifying a plurality of data objects in the data structure that have the one or more specified attributes;
identifying, from the plurality of data objects, complementary data objects as the one or more different items, the complementary data objects being a portion of the plurality of data objects having the most user interactions according to the data structure.

8. The method of claim 7, wherein the plurality of data objects correspond to physical items searchable on a network site, and wherein the user interactions are interactions with representations of the physical items on the network site.

9. The method of claim 8, wherein the representations of the physical items include at least one of: a webpage, one or more images of the physical items; and wherein the display device is a display of the client device of the user or of an additional client device of an additional user.

10. The method of claim 1, wherein the user interactions are interactions on a network site and include at least one of: views, saves, likes, purchases.

11. The method of claim 1, wherein the one or more different items are identified using operations comprising:
identifying a plurality of data objects in the data structure that have the one or more specified attributes;
identifying, from the plurality of data objects, complementary data objects as the one or more different items, the complementary data objects being items on a network site that an additional user has interacted with on the network site to indicate the items satisfy the design motif from the criteria data, the interactions of the additional user on the network site including at least one of: selecting the items as complementary items, liking the items through network site, saving the items on the network site.

12. The method of claim 1, wherein the data structure is a network graph comprising nodes as the plurality of data objects, the nodes being connected by edges, the nodes corresponding to physical items and users, the edges corresponding to interactions between user nodes and item nodes.

13. The method of claim 1, wherein the one or more attributes include at least one of: price, color, material, shape.

14. The method of claim 1, wherein the one or more attributes specify a relationship of appearing in a same stored image together.

15. A system comprising:
one or more processors of a machine; and
a memory storing instructions that, when executed by the one or more processors, cause the machine to perform operations comprising:
receive, from a client device of a user, criteria data specifying a design motif for physical items;
identify a set of one or more physical items that correspond to the criteria data;
receive, from the client device, a request to modify the set of one or more physical items to include one or more different items that satisfy the criteria data and one or more attributes of the different items specified in the request;
responsive to the request, generate the one or more different items by accessing a data structure to identify the one or more different items that satisfy the criteria data and satisfy the one or more specified attributes; and
causing a presentation of the generated different items on a display device.

16. The system of claim 15, wherein the request to modify is generated using a graphical user interface element that selects a new value, from a range of values, using the one or more specified attributes of the different items.

17. The system of claim 15, wherein the one or more different items are identified using operations comprising:
identifying a plurality of data objects in the data structure that have the one or more specified attributes;
identifying, from the plurality of data objects, complementary data objects as the one or more different items, the complementary data objects being a portion of the plurality of data objects having the most user interactions according to the data structure.

18. The system of claim 17, wherein the plurality of data objects correspond to physical items searchable on a network site, and wherein the user interactions are interactions with representations of the physical items on the network site.

19. The system of claim 15, wherein the one or more different items are identified using operations comprising:
identifying a plurality of data objects in the data structure that have the one or more specified attributes;
identifying, from the plurality of data objects, complementary data objects as the one or more different items, the complementary data objects being items on a network site that an additional user has interacted with on the network site to indicate the items satisfy the design motif from the criteria data, the interactions of the additional user on the network site including at least one of: selecting the items as complementary items, liking the items through network site, saving the items on the network site.

20. A machine-readable storage device embodying instructions that, when executed by a machine, cause the machine to perform operations comprising:
receiving, from a client device of a user, criteria data specifying a design motif for physical items;
identifying a set of one or more physical items that correspond to the criteria data;
receiving, from the client device, a request to modify the set of one or more physical items to include one or more different items that satisfy the criteria data and one or more attributes of the different items specified in the request;
responsive to the request, generating the one or more different items by accessing a data structure to identify the one or more different items that satisfy the criteria data and satisfy the one or more specified attributes; and
causing, using at least one processor of a machine, a presentation of the generated different items on a display device.
